(19) United States
(12) Patent Application Publication
(10) Pub. No.: US 2001/0006938 A1
(43) Pub. Date: Jul. 5, 2001

(54) Use of fabric conditioning compositions for ironing benefits

(76) Inventors: David Stephen Grainger, Bebington (GB); Karen Jane Ellson, Bebington (GB); Janice Elaine Wright, Bebington (GB)

Correspondence Address: UNILEVER, PATENT DEPARTMENT, 45 RIVER ROAD, EDGEWATER, NJ, 07020, US

(21) Appl. No.: 09/741,397

(22) Filed: Dec. 20, 2000

(30) Foreign Application Priority Data
Dec. 22, 1999 (GB) 9930433.9

(51) Int. Cl. C11D 3/00; D06L 1/00; C11D 1/00

(52) U.S. Cl. 510/515; 510/516; 510/517; 510/504

(57) ABSTRACT

The present invention provides the use of a fabric treatment composition to provide anti-creasing properties and/or ease or ironing benefits to a fabric wherein said composition comprises;

(i) an oily sugar derivative which is a liquid or soft solid derivative of a cyclic polyol or of a reduced saccharide, said derivative resulting from 35 to 100% of the hydroxyl groups in said polyol or in said saccharide being esterified or etherified, wherein said derivative has two or more ester or ether groups independently attached to a C₈-C₂₂ alkyl or alkenyl chain, and

(ii) one or more deposition aid(s).

According to a further aspect the present invention provides a method of reducing the creasing of fabric by applying thereto during a laundering operation the composition defined above, and a method of providing ease of ironing benefits by applying thereto during a laundering operation the composition defined above.

### TECHNICAL FIELD

The present invention relates to the use of fabric conditioning compositions comprising certain oily sugar derivatives to provide reduced creasing and/or easier ironing of fabrics treated with the compositions.

### BACKGROUND AND PRIOR ART

Ironing of fabrics after laundering is generally regarded as one of the most unpopular household chores. There have, to date, been two approaches taken to making ironing less of a household chore.

The first approach has been to make the ironing process easier (involving less time and effort for the person doing the ironing). This is referred to herein as an ease of ironing effect. For example silicone oils have been used in rinse conditioners to give this effect.

The second approach has been to try to prevent garments becoming creased (this is referred to herein as an anti-creasing effect) during the laundering process, thus eliminating the need for ironing. This approach is disclosed in e.g. EP 150 872. This second approach has several additional advantages over the first; firstly, it is attractive to consumers because they will not have to iron the fabrics at all (thus saving time and effort, and, avoiding a household chore completely) and secondly it reduces energy consumption and hence is environmentally favourable. This second approach had generally been found to be more difficult to achieve. However, it has been found that increased levels of active ingredients are often required in the product to achieve the effect.

Thus there is a need to provide alternative, and more effective methods of making the ironing process easier or to eliminate the need for ironing. In particular methods of doing both are particularly advantageous as there are certain occasions on which the consumer would always iron fabrics even if they are not especially creased, for example to give sharp creases. In this case it would be desirable both to iron only the parts required, and to make this part of the ironing process as easy as possible.

The present invention is directed towards providing reduced creasing of fabric during laundering and/or easier ironing of fabric that has been laundered.

It has been found that, surprisingly, that the compositions as described herein, comprising oily sugar derivatives, may be used to provide an anti-creasing effect and/or ease of ironing effect.

Oily sugar derivatives are known in fabric softener compositions.

WO 98/16538 (Unilever) discloses fabric softening compositions comprising liquid or soft solid derivatives of a cyclic polyol or a reduced saccharide which give good softening and retain absorbency of the fabric.

Our co-pending UK patent application GB 9911437.3 discloses fabric softening compositions comprising liquid or soft solid derivatives of a cyclic polyol or a reduced saccharide, at least one anionic surfactant, and at least one cationic polymer.

Our co-pending UK patent application GB 9911434.0 discloses fabric softening compositions comprising a liquid or soft solid derivative of a cyclic polyol or a reduced saccharide, the derivatives having at least one unsaturated bond in the alkyl or alkenyl chains, a deposition aid and one or more antioxidants.

WO 96/15213 (Henkel) discloses textile softening agents containing alkyl, alkenyl and/or acyl group containing sugar derivatives, which are solid after esterification, in combination with nonionic and cationic emulsifiers.

EP 0 380 406 (Colgate-Palmolive) discloses detergent compositions comprising a saccharide or reduced saccharide ester containing at least one fatty acid chain.

WO 95/00614 (Kao Corporation) discloses softening compositions comprising polyhydric alcohol esters and cationised cellulose.

U.S. Pat. No. 5,447,643 (Hüls) discloses aqueous fabric softeners comprising nonionic surfactants and mono, di or tri fatty acid esters of certain polyols.

However none of the above prior art documents refers to an ease of ironing effect or an anti-creasing effect which has been found to be obtained by using the compositions of the invention.

The principal advantages of the invention include that both the above technical effects have been found to be achieved from the same fabric softening composition, and in addition, these compositions provide good softening.

It has also been found that anti-creasing benefits are achieved from detergent compositions comprising the oily sugar derivatives referred to herein.

### DEFINITION OF THE INVENTION

According to one aspect the present invention provides the use of a fabric treatment composition to provide anti-creasing properties and/or ease or ironing benefits to a fabric wherein said composition comprises;

(i) an oily sugar derivative which is a liquid or soft solid derivative of a cyclic polyol or of a reduced saccharide, said derivative resulting from 35 to 100% of the hydroxyl groups in said polyol or in said saccharide being esterified or etherified, and wherein said derivative has two or more ester or ether groups independently attached to a C₈-C₂₂ alkyl or alkenyl chain, and

(ii) one or more deposition aid(s).

According to a further aspect the present invention provides a method of reducing the creasing of fabric by applying thereto during a laundering operation the composition defined above.

According to a further aspect the present invention provides a method of providing ease of ironing benefits by applying thereto during a laundering operation the composition defined above.

According to a further aspect the present invention provides a fabric treated with the composition as described above.

### DETAILED DESCRIPTION OF THE INVENTION

The compositions used to provide the above mentioned effects comprise an oily sugar derivative, as herein defined, and at least one deposition aid.

### Oily Sugar Derivative

The oily sugar derivative is a liquid or soft solid derivative of a cyclic polyol or of a reduced saccharide, said derivative resulting from 35 to 100% of the hydroxyl groups in said polyol or in said saccharide being esterified or etherified. The derivative has two or more ester or ether groups independently attached to a C₈-C₂₂ alkyl or alkenyl chain.

The oily sugar derivatives of the invention are also referred to herein as “derivative-CP” and “derivative-RS” dependent upon whether the derivative is a product derived from a cyclic polyol or from a reduced saccharide starting material respectively.

Preferably the derivative-CP and derivative-RS contain 35% by weight tri or higher esters, e.g. at least 40%.

Preferably 35 to 85% most preferably 40 to 80%, even more preferably 45 to 75%, such as 45 to 70% of the hydroxyl groups in said cyclic polyol or in said reduced saccharide are esterified or etherified to produce the derivative-CP and derivative-RS respectively.

For the derivative-CP and derivative-RS, the tetra, penta etc prefixes only indicate the average degrees of esterification or etherification. The compounds exist as a mixture of materials ranging from the monoester to the fully esterified ester. It is the average degree of esterification as determined by weight that is referred to herein.

The derivative-CP and derivative-RS used do not have substantial crystalline character at 20°C. Instead they are preferably in a liquid or soft solid state, as hereinbelow defined, at 20°C.

The starting cyclic polyol or reduced saccharide material is esterified or etherified with C8-C22 alkyl or alkenyl chains to the appropriate extent of esterification or etherification so that the derivatives are in the requisite liquid or soft solid state. These chains may contain unsaturation, branching or mixed chain lengths.

Typically the derivative-CP or derivative-RS has 3 or more, preferably 4 or more, for example 3 to 8, e.g. 3 to 5, ester or ether groups or mixtures thereof. It is preferred if two or more of the ester or ether groups of the derivative-CP and derivative-RS are independently of one another attached to a C₈ to C₂₂ alkyl or alkenyl chain. The alkyl or alkenyl groups may be branched or linear carbon chains.

The derivative-CPs are preferred for use as the oily sugar derivative. Inositol is a preferred cyclic polyol, and Inositol derivatives are especially preferred.

In the context of the present invention the terms derivative-CP and derivative-RS encompass all ether or ester derivatives of all forms of saccharides, which fall into the above definition. Examples of preferred saccharides for the derivative-CP and derivative-RS to be derived from are monosaccharides and disaccharides.

Examples of monosaccharides include xylose, arabinose, galactose, fructose, sorbose and glucose. Glucose is especially preferred. An example of a reduced saccharide is sorbitan. Examples of disaccharides include maltose, lactose, cellobiose and sucrose. Sucrose is especially preferred.

If the derivative-CP is based on a disaccharide it is preferred if the disaccharide has 3 or more ester or ether groups attached to it. Examples include sucrose tri, tetra and penta esters.

Where the cyclic polyol is a reducing sugar it is advantageous if each ring of the derivative-CP has one ether group, preferably at the C₁ position. Suitable examples of such compounds include methyl glucose derivatives.

Examples of suitable derivative-CPs include esters of alkyl(poly)glucosides, in particular alkyl glucoside esters having a degree of polymerisation from 1 to 2.

The HLB of the derivative-CP and derivative-RS is typically between 1 and 3.

The derivative-CP and derivative-RS may have branched or linear alkyl or alkenyl chains (with varying degrees of branching), mixed chain lengths and/or unsaturation. Those having unsaturated and/or mixed alkyl chain lengths are preferred.

One or more of the alkyl or alkenyl chains (independently attached to the ester or ether groups) may contain at least one unsaturated bond.

For example, predominantly unsaturated fatty chains may be attached to the ester/ether groups, e.g. those attached may be derived from rape oil, cotton seed oil, soybean oil, oleic, tallow, palmitoleic, linoleic, erucic or other sources of unsaturated vegetable fatty acids.

The alkyl or alkenyl chains of the derivative-CP and derivative-RS are preferably predominantly unsaturated, for example sucrose tetratallowate, sucrose tetrarapeate, sucrose tetraoleate, sucrose tetraesters of soybean oil or cotton seed oil, cellobiose tetraoleate, sucrose trioleate, sucrose triapeate, sucrose pentaoleate, sucrose pentarapeate, sucrose hexaoleate, sucrose hexarapeate, sucrose triesters, pentaesters and hexaesters of soybean oil or cotton seed oil, glucose trioleate, glucose tetraoleate, xylose trioleate, or sucrose tetra-,tri-, penta- or hexa- esters with any mixture of predominantly unsaturated fatty acid chains.

However some derivative-CPs and derivative-RSs may be based on alkyl or alkenyl chains derived from polyunsaturated fatty acid sources, e.g. sucrose tetralinoleate. It is preferred that most, if not all, of the polyunsaturation has been removed by partial hydrogenation if such polyunsaturated fatty acid chains are used.

The most highly preferred liquid or soft solid derivative-CPs and derivative-RSs are any of those mentioned in the above three paragraphs but where the polyunsaturation has been removed through partial hydrogenation.

Particularly effective derivative-CPs and derivative-RSs are obtained by using a fatty acid mixture (to react with the starting cyclic polyol or reduced saccharide) which comprises a mixture of tallow fatty acid and oleyl fatty acid in a weight ratio of 10:90 to 90:10, more preferably 25:75 to 75:25, most preferably 30:70 to 70:30. A fatty acid mixture comprising a mixture of tallow fatty acid and leyl fatty acid in a weight ratio of 60:40 to 40:60 is specially preferred.

Particularly preferred are fatty acid mixtures comprising a eight ratio of approximately 50 wt % tallow chains and 50 wt % oleyl chains. It is especially preferred that the fatty acid fieldstock for the chains consists of only tallow and oleyl fatty acids.

Preferably 40% or more of the chains contain an unsaturated bond, more preferably 50% or more, most preferably 60% or more e.g. 65% 95%.

Oily sugar derivatives suitable for use in the compositions include sucrose pentalaurate, sucrose tetraoleate, sucrose pentaerucate, sucrose tetraerucate, and sucrose pentaoleate and the like. Suitable materials include some of the Ryoto series available from Mitsubishi Kagaku Foods Corporation.

The liquid or soft solid derivative-CPs and derivative-RSs are characterised as materials having a solid:liquid ratio of between 50:50 and 0:100 at 20°C. as determined by T₂ relaxation time NMR, preferably between 43:57 and 0:100, most preferably between 40:60 and 0:100, such as, 20:80 and 0:100. The T₂ NMR relaxation time is commonly used for characterising solid:liquid ratios in soft solid products such as fats and margarines. For the purpose of the present invention, any component of the NMR signal with a T₂ of less than 100 microsecond is considered to be a solid component and any component with T₂ greater than 100 microseconds is considered to be a liquid component.

The liquid or soft solid derivative-CPE and derivative-RSE can be prepared by a variety of methods well known to those skilled in the art. These methods include acylation of the cyclic polyol or of a reduced saccharide with an acid chloride; trans-esterification of the cyclic polyol or of a reduced saccharide material with short chain fatty acid esters in the presence of a basic catalyst (e.g. KOH); acylation of the cyclic polyol or of a reduced saccharide with an acid anhydride, and, acylation of the cyclic polyol or of a reduced saccharide with a fatty acid. Typical preparations of these materials are disclosed in U.S. Pat. No.4,386,213 and AU 14416/88 (Procter and Gamble).

The compositions preferably comprise between 0.5%-30% wt of the oily sugar derivatives, more preferably 1-20% wt, most preferably 1.5-20% wt, based on the total weight of the composition.

### Deposition Aid

The compositions comprise one or more deposition aid(s).

In the context of the present invention a deposition aid is defined as any material that aids deposition of the oily sugar derivative onto a fabric during the laundering process.

The deposition aid may be selected from cationic surfactants, cationic fabric softening compounds, cationic polymers and mixtures thereof.

Most preferably the deposition aid is a cationic fabric softening compound or a cationic surfactant.

(i) Cationic fabric softening compounds

The compositions may comprise one or more cationic fabric softening compounds as the deposition aid. The cationic fabric softening compounds may be ester-linked quaternary ammonium fabric softening compounds or non-ester linked quaternary ammonium fabric softening compounds.

The ester-linked quaternary ammonium fabric softening compounds are herein referred to as “the ester-softening compound”. The non-ester linked quaternary ammonium fabric softening compounds are herein referred to as “the non-ester softening compound”.

The cationic fabric softening compounds preferably has two or more, e.g. three, C₈₋₂₈ alkyl or alkenyl chains connected to a nitrogen atom, preferably via at least one ester link, more preferably for ester-softening compounds via two or more ester linkages.

Especially suitable compounds have two or more alkyl or alkenyl chains each having an average chain length equal to, or greater than C₁₄, more preferably, equal to or greater C₁₆. Most preferably at least 50% of the total number of alkyl or alkenyl chains have a chain length equal to, or greater than C₁₈.

It is advantageous for environmental reasons if the ester-softening compound is biologically degradable. It is also preferred if the alkyl or alkenyl chains of the ester-softening compound are predominantly linear.

One preferred type of ester-softening compound is a quaternary ammonium material represented by formula (I):

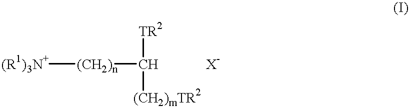

Wherein T is

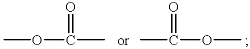

each R¹ group is independently selected from C₁₋₄, alkyl or hydroxyalkyl or C₂₋₄ alkenyl groups; and wherein each R² group is independently selected from C₈₋₂₈ alkyl or alkenyl groups, X⁻is any suitable anion including a halide, acetate or lower alkosulphate ion, such as chloride or methosulphate, and n is 0 or an integer from 1-5, and m is from 1 to 5.

Preferred materials of this class such as 1,2 bis[hardened tallowoyloxy]-3-trimethylammonium propane chloride and their method of preparation are, for example, described in U.S. Pat. No.4,137,180 (Lever Brothers). Preferably these materials comprise small amounts of the corresponding monoester as described in U.S. Pat. No.4,137,180 for example 1-hardened tallowoyloxy-2-hydroxy 3-trimethylammonium propane chloride.

A second preferred type of ester-softening compound is a quaternary ammonium material represented by the formula (II):

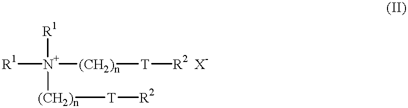

T, R¹, R², n, and X⁻are as defined above.

Within this class di(tallowoyloxyethyl) dimethyl ammonium chloride and methyl bis-[ethyl (tallowoyl)]-2-hydroxyethyl ammonium methyl sulphate are especially preferred. The tallow chains in these compounds may be hardened and may even be fully unsaturated, i.e. preferred compounds also include di(hardened tallowoyloxy ethyl) dimethyl ammonium chloride and methyl bis-[ethyl(hardened tallowoyl)] 2-hydroxyethyl ammonium methyl sulphate. Commercially available compounds include those in the Tetranyl range (ex Kao) and Stepantex range (ex Stepan).

Also suitable are derivatives of the above formula where the (CH₂)ₙ chain has a pendent alkyl chain e.g. a methyl chain. Examples include the such cationic compounds described in WO 99/35223 and WO 99/35120 (Witco)

A third preferred type of ester-softening compound is a quaternary ammonium material represented by the formula (III):

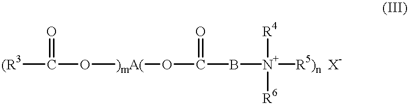

wherein X⁻is as defined above, A is an (m+n) valent radical remaining after the removal of (m+n) hydroxy groups from an aliphatic polyol having p hydroxy groups and an atomic ratio of carbon to oxygen in the range of 1.0 to 3.0 and up to 2 groups per hydroxy group selected from ethylene oxide and propylene oxide, m is 0 or an integer from 1 to p-n, n is an integer from 1 to p-m, and p is an integer of at least 2, B is an alkylene or alkylidene group containing 1 to 4 carbon atoms, R³, R⁴, R⁵ and R⁶ are, independently from each other, straight or branched chain C₁-C₄₈ alkyl or alkenyl groups, optionally with substitution by one or more functional groups and/or interruption by at most 10 ethylene oxide and/or propylene oxide groups, or by at most two functional groups selected from;

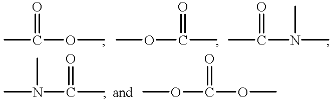

or R⁴ and R⁵ may form a ring system containing 5 or 6 atoms in the ring, with the proviso that the average compound either has at least one R group having 22-48 carbon atoms, or at least two R groups having 16-20 carbon atoms, or at least three R groups having 10-14 carbon atoms. Preferred compounds of this type are described in EP 638 639 (Akzo).

The non-ester softening compound preferably has the alkyl or alkenyl chain lengths referred to above for the non-ester softening compound.

One preferred type of non-ester softening compound is a quaternary ammonium material represented by formula (IV):

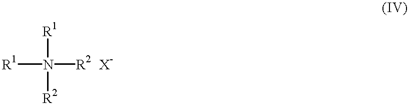

wherein each R¹ group is independently selected from C₁₋₄ alkyl, hydroxyalkyl or C₂₋₄ alkenyl groups; R² group is independently selected from C₈₋₂₈ alkyl or alkenyl groups, and X⁻is as defined above.

A preferred material of formula (IV) is di-hardened tallow-dimethyl ammonium chloride, sold under the Trademark ARQUAD 2HT by Akzo Nobel.

If the fabric treatment compositions are fabric softening compositions, then they preferably comprise a total amount of between 0.5% wt-30% by weight of the cationic fabric softening compounds,more preferably 1%-25%, even more preferably 1.5-20%, most preferably 2%-15%, based on the total weight of the composition.

When the cationic fabric softening compound is present, the weight ratio of the softening compound to the oily sugar derivatives is preferably in the range 99:1 to 1:10, preferably 10:1 to 1:5, more preferably 5:1 to 1:1, most preferably 4:1 to 1:1.

The cationic fabric softening compound is preferably present in the composition in an amount of 50%-99% by weight, preferably 55%-85%, based on the total weight of the softening compound and oily sugar derivative.

If the oily sugar derivative or quaternary ammonium softening compound comprises hydrocarbyl chains formed from fatty acids or fatty acyl compounds which are unsaturated or at least partially unsaturated (e.g. having an iodine value of from 5 to 140, preferably 5 to 100, more preferably 5 to 60, most preferably 5 to 40, e.g. 5 to 25), then the cis:trans isomer weight ratio in the fatty acid/fatty acyl compound is greater than 20/80, preferably greater than 30/70, more preferably greater than 40/60, most preferably greater than 50/50, e.g. 70/30 or greater. It is believed that higher cis:trans isomer weight ratios afford the compositions comprising the compound better low temperature stability and minimal odour formation. Suitable fatty acids include Radiacid 406, ex Fina.

Saturated and unsaturated fatty acids/acyl compounds may be mixed together in varying amounts to provide a compound having the desired iodine value.

Fatty acids/acyl compounds may also be, at least partially hydrogenated to achieve lower iodine values.

Of course, the cis:trans isomer weight ratios can be controlled during hydrogenation by methods known in the art such as by optimal mixing, using specific catalysts and providing high H₂ availability.

(ii) Cationic surfactant

The compositions may comprise one or more cationic surfactants as the deposition aid. These surfactants preferably have a single C₈-C₂₈ alkyl or alkenyl chain, most preferably a single C₈-C₂₀ alkyl or alkenyl chain, more preferably a single C₁₀-C₁₈ alkyl or alkenyl chain.

Suitable cationic surfactants include water soluble single long-chain quaternary ammonium compounds such as cetyl trimethyl ammonium chloride, cetyl trimethyl ammonium bromide, or any of those listed in European Patent No. 258 923 (Akzo).

The cationic surfactant may be an alkyl tri-methylammonium methosulphate or chloride or alkyl ethoxylalkyl ammonium methosulphate or chloride. Examples include coconut pentaethoxymethyl ammonium methosulphate and derivatives in which at least two of the methyl groups on the nitrogen atom are replaced by (poly)alkoxylated groups. Preferably, the cation in the cationic surfactant is selected from alkyl tri-methylammonium methosulphates and their derivatives, in which, at least two of the methyl groups on the nitrogen atom are replaced by (poly)alkoxylated groups.

Any suitable counter-ion may be used in the cationic surfactant. Preferred counter-ions for the cationic surfactants include halogens (especially chlorides), methosulphate, ethosulphate, tosylate, phosphate and nitrate.

Suitable commercially available cationic surfactants include the Ethoquad range from Akzo, e.g. Ethoquad 0/12 and Ethoquad HT/25.

The cationic surfactant is preferably present in an amount of 0.01 to 5% by weight, more preferably 0.05%-3%, even more preferably 0.1%-2% based on the total weight of the composition.

Fabric treatment compositions which comprise cationic surfactants may be compositions for use in the wash cycle (e.g. detergent compositions) or rinse cycle compositions (e.g. fabric softening compositions).

(iii) cationic polymers

The compositions may comprise one or more one cationic polymers as the deposition aid. If the cationic polymer is used as the deposition aid then preferably at least one anionic surfactant, nonionic surfactant and/or zwitterionic surfactant is present.

Suitable cationic polymers include cationic guar polymers such as; the JAGUAR® series of polymers (ex Rhodia), cationic cellulose derivatives such as CELQUATS® (ex National Starch), UCARE® polymers (ex Amerchol), cationic starches e.g. potato starch such as SOFTGELS®, e.g. BDA, and BD (both ex Avebe) and the C* bond polymers series from Cerestar, AMYLOFAX® and SOLVITOSE® polymers (both ex Avebe), POLYGEL polymers K 100 and K200 (ex Sigma), cationic polyacrylamides such as PCG (ex Allied Colloids) and FLOCAID® series of polymers (ex National Starch) and cationic chitosan derivatives.

The cationic polymers may be present in the compositions in an amount of 0.01 to 5% by weight based upon the total weight of the composition, more preferably 0.02-2.5%, such as 0.5-2%.

If the fabric treatment composition comprises a cationic polymer then it is preferred though not essential that the composition is a wash cycle composition (e.g. detergent composition).

### Water

The compositions preferably contain water in an amount of at least 40% by weight, more preferably at least 50%, for example at least 60%, based on the total weight of the composition.

### Other Optional Ingredients

The compositions may comprise one or more nonionic surfactants. Preferably the nonionic surfactant has a single C₈-C₂₈ alkyl or alkenyl chain, most preferably a single C₈-C₂₀ alkyl or alkenyl chain, more preferably a single C₁₀-C₁₈ alkyl or alkenyl chain.

Suitable nonionic surfactants include the condensation products of C₈-C₃₀ primary or secondary linear or branched alcohols preferably C₁₀-C₂₂ alcohols, alkoxylated with 10 or more moles of alkylene oxide, preferably 10-25 moles of alkylene oxide, more preferably between 15 and 20 moles of alkylene oxide. Preferably the alkylene oxide is ethylene oxide although it may be/include propoxylate groups. The alcohols may be saturated or unsaturated.

Suitable alcohol ethoxylates include the condensation products of coconut fatty alcohol with 15-20 moles of ethylene oxide, e.g. coco 20 ethoxylate, and, condensation products of tallow alcohol with 10-20 moles of ethylene oxide, e.g. tallow 15 ethoxylate. Other suitable examples include alkyl polyglucosides and other sugar based surfactants e.g. ethoxylated sorbitans.

The nonionic surfactants preferably have an HLB of from about 10 to about 20, for example from 11 to 16.

The nonionic surfactant is preferably present in an amount of 0.01 to 5% by weight, more preferably 0.05%-3%, even more preferably 0.1%-2% based on the total weight of the composition.

The compositions typically comprise a perfume of a type conventionally used in detergent compositions or fabric softening compositions.

Especially preferred optional ingredients are antioxidants. The compositions preferably comprise one or more antioxidants e.g. in an amount of 0.0001% to 1% by weight (in total). Preferably the antioxidant comprises at least one initiation inhibitor antioxidant and/or at least one propagation inhibitor as described in our co-pending application number GB 9911434.0.

The compositions may also contain fatty acids, for example C₈-C₂₄ alkyl or alkenyl monocarboxylic acids, or, polymeric carboxylic acids. Preferably saturated fatty acids are used, in particular, hardened tallow C₁₆-C₁₈ fatty acids.

It may be advantageous if a viscosity control agent (to achieve a viscosity that is desired by the consumer) is present in liquid compositions. These agents may also help to improve the stability of the compositions, for example by slowing down, or stopping, the tendency of the composition to separate. Any such agent conventionally used in detergent compositions or rinse conditioners may be used. For example synthetic polymers e.g. polyacrylic acid, poly vinyl pyrrolidone, polyethylene, carbomers, cross-linked polyacrylamides such as ACOSOL® 880/882 polyethylene and polyethylene glycols may be used.

Other polymers may also be included in the compositions. Suitable polymers include nonionic polymers such as PLURONICS® (ex BASF), dialkyl PEGs, cellulose derivatives as described in GB 213 730 (Unilever), hydroxy ethyl cellulose, starch, and hydrohobically modified nonionic polyols such as ACUSOL® 880/882 (ex Rohm & Haas).

The nonionic polymer may be present in the compositions in an amount of 0.01-5% by weight based upon the total weight of the composition, more preferably 0.02-2.5%, such as 0.05-2%.

It is especially preferred that polymers, especially cationic polymers, are included if the total amount of oily sugar derivative and, if present, cationic fabric softening agent is about or below 10 wt %. It is especially preferred that the polymers are added as part of the pre-mixtures described below in the preferred method of preparation for compositions where a cationic fabric softening agent is included.

Deflocculating polymers as described in EP 415 698 and EP 458 599 may also be included.

### Detergent Compositions

The compositions may also comprise an anionic surfactant. Any suitable anionic surfactant conventionally used in laundry compositions may be used. The anionic surfactant may be chosen from soap and non-soap anionic surfactants and mixtures thereof.

Many suitable detergent active compounds are available and are fully described in the literature, for example, in Surface-Active Agents and Detergents , Volumes I and II, by Schwartz, Perry and Berch.

Anionic surfactants are well-known to those skilled in the art. Examples include alkylbenzene sulphonates, particularly linear alkylbenzene sulphonates having an alkyl chain length of C₈-C₁₅; primary and secondary alkylsulphates, particularly C₈-C₁₅ primary alkyl sulphates; alkyl ether sulphates; olefin sulphonates; alkyl xylene sulphonates; dialkyl sulphosuccinates; and fatty acid ester sulphonates. Sodium salts are generally preferred.

The compositions may comprise 0.1% to 10% by weight anionic surfactant, most preferably 0.5% to 3.5%.

### Optional Minor Ingredients

The composition may also contain one or more optional ingredients conventionally used in detergent compositions or fabric softening compositions, selected from dyes, preservatives, antifoams, such as electrolytes, non-aqueous solvents, pH buffering agents, perfume carriers, fluorescers, hydrotropes, antiredeposition agents, enzymes, optical brightening agents, opacifiers, anti-shrinking agents, anti-wrinkle agents, anti-spotting agents, germicides, fungicides, anti-corrosion agents, drape imparting agents, antistatic agents, sunscreens and colour care agents.

### Method of Preparation

If the composition does not include a cationic fabric softening compound having two or more, e.g. three, C₈-C₂₈ alkyl or alkenyl chains then the composition may be prepared by any suitable method, such as simple mixing together or co-melting the oily sugar derivative and one or more of the other ingredients.

If a cationic fabric softening compound having two or more, e.g. three, C₈-C₂₈ alkyl or alkenyl chains is included in the composition, the composition is preferably not prepared by directly co-melting together the softening compound and the oily sugar derivative as is conventional in the art. The comments below refer to the preferred method of making these types of compositions.

It is especially preferred that the compositions, when they comprise a cationic fabric softening compound are prepared by a method that includes the step wherein the softening compound and/or the oily sugar derivative is/are separately mixed with another active component of the fabric softening composition to form a pre-mixture prior to the admixing of the softening compound with the oily sugar derivative to produce the fabric softening composition. The pre-mixing with another active component to form a pre-mixture prior to said admixing may also apply to both the softening compound and the oily sugar derivative.

The methods below refer to the preparation of compositions comprising cationic fabric softening compound having two or more C₈-C₂₈ alkyl or alkenyl chains.

The term “active component” as used herein defines a component of the compositions which has a functional role therein and which is supplied as a separate raw material product. The term includes nonionic and cationic surfactants and perfumes. The term does not include water, dyes, preservatives or any of the minor optional ingredients recited herein. Preferably both the derivative and the softening compound are pre-mixed in this manner.

The “active component” is preferably a cationic surfactant having a single C₈-C₂₈ alkyl or alkenyl chain, a nonionic surfactant or a perfume.

However, the term “active component” does not include where a component raw material is supplied with a minor amount of an “active component” included as part of that raw material as obtained from the manufacturer. Thus, for example, a cationic fabric softening compound raw material (supplied as comprising a minor amount of a surfactant) mixed directly with an oily sugar derivative raw material in the absence of another “active component” raw material as defined above would not form part of the preferred method.

The separate pre-mixing of the softening compound and/or the oily sugar derivative with another active component of the fabric softening composition to form said pre-mixture may occur in any known manner.

The method may incorporate one or more of the following ways of forming the pre-mixture(s).

According to one preferred method the oily sugar derivative is pre-mixed with water and/or with at least one cationic surfactant having a single C₈-C₂₈ alkyl or alkenyl chain, and/or nonionic surfactant, to form a pre-mixture and subsequently the softening compound, in at least partially liquid or molten state, is mixed with said pre-mixture.

For this method, the pre-mixture formed from the oily sugar derivative is preferably at a temperature of at least 30°C., preferably at least 40°C., most preferably at least 50°C., when the softening compound is mixed therewith. However the resultant mixture obtained from the pre-mixture and the softening compound being mixed together may subsequently be heated to said temperature.

According to another preferred method, the softening compound is pre-mixed with water and/or with at least one cationic surfactant having a single C₈-C₂₈ alkyl or alkenyl chain, and/or a nonionic surfactant, to form a pre-mixture and subsequently the oily sugar derivative is mixed with said pre-mixture.

For this method it is especially preferred that the softening compound is pre-mixed with at least one nonionic surfactant either alone or in the presence of water.

It is especially preferred that if optional minor ingredients which are polyelectrolytes are present, such as preservative, these are added after the oily sugar derivatives and the softening compound have been brought into contact. If these components are added before this occurs then the compositions may not be stable and/or complexation of the oily sugar derivatives and the softening compound may occur.

### Product Form

The compositions of the invention may be in any physical form including gels, liquids, powders and granules. Liquids, especially emulsions, are preferred. Emulsion compositions are particularly preferred.

### Composition pH

The compositions of the invention preferably have a pH from 1.5 to 7, more preferably from 1.5 to 5.

### Method of Treating Fabrics

The fabrics which are to be treated with the compositions described herein may be treated by any suitable laundering method. The preferred methods are by treatment of the fabric during a domestic laundering process such as by soaking, or, in the rinse cycle of a domestic washing process or, in the washing cycle of a domestic washing process.

### EXAMPLES

The invention is further illustrated by the following non-limiting examples. Further examples within the scope of the present invention will be apparent to the man skilled in the art.

All percentages in the following examples are by weight based upon the total weight of the composition and refer to the amount of the raw material added unless otherwise stated. The examples according to the invention are denoted by numbers. The comparative examples are denoted by letters.

### Example 1

The following composition was prepared;

| | % by weight |
|---|---|
| Cetyl trimethyl ammonium chloride | 6.0% |
| (1) | |
| Sucrose tetraerucate (2) | 14.25% |
| Polymer (3) | 2.11% |
| Water | to 100% |

(1) A 25% by weight solution in water available from Aldrich Chemicals.
(2) sucrose polyerucate, available as Ryoto ER290 from Mitsubishi Kagaku Foods Corporation. The degree of esterification is given in the data sheet as 4-6.
(3) Neutralised FLOCAID ® 34 (ex National Starch) supplied as a 24 wt % solution.

Comparative Example A was a commercially available concentrated rinse conditioner. Comparative Example B received no treatment composition but was rinsed in water only.

Sixteen test cloths (cotton sheeting) measuring 40 cm×40 cm were washed at 40°C. in a Miele FLA washing machine using 90 g of a commercially available laundry powder. A 2 Kg dummy' load of cotton sheeting was used to simulate the effects of having a full load in the machine. Where a rinse conditioner composition was used, it was added in an amount to provide 0.25% by weight of the active softener compounds on the fabric. The cloths were then treated in different ways according to regimes A to D below. Tumble-drying took place until the cloths were dry in the case of Regimes B and D. Where ironing took place (i.e. regimes A and B), the cloths were ironed on one side for 10 seconds only prior to storage of the cloths under controlled temperature and humidity conditions (65% RH and 20°C.) overnight prior to being tested by a panel of assessors. Four clothes-were treated with each regime and each cloth was panelled by 5 people. Thus there were twenty measurements taken per regime. The cloths were assessed using Monsanto Creasing Standards (1 to 5 scoring system with 5 being flat and 1 being very creased). The results are shown in Table 1.

TABLE 1
0.25% weight of active fabric softener compound on
the fabric.

| | A) line | B tumble | C) line | D) tumble |
|---|---|---|---|---|
| | dried and | dried and | dried and | dried and |
| Treatment | ironed | ironed | not ironed | not ironed |
| Example A | 3.46 | 3.46 | 2.12 | 2.13 |
| Example B | 3.69 | 2.91 | 2.01 | 1.62 |
| Example 1 | 3.95 | 3.93 | 1.78 | 2.41 |

Clearly, whilst there is a slight loss of performance with the samples which were unironed and line dried (C), there are benefits with the other three regimes (A, B and D). Regimes A and B demonstrate very clearly the ease of ironing benefit obtained whilst regime D shows the anticreasing effect.

A second test was carried out using the same examples and the same regimes but with twice the amount of active softener compound on the fabric (i.e. 0.5% active on weight of fabric). The results are shown in Table 2.

TABLE 2
0.5% weight of active fabric softener compound on
the fabric.

| | A) line | B) tumble | C) line | D) tumble |
|---|---|---|---|---|
| | dried and | dried and | dried and | dried and |
| Treatment | ironed | ironed | not ironed | not ironed |
| Example A | 2.72 | 2.90 | 1.57 | 1.16 |
| Example B | 2.51 | 3.34 | 1.58 | 1.46 |
| Example 1 | 2.69 | 3.45 | 1.65 | 1.67 |

Again Example 1 performs better Example A in 3 out of the 4 regimes (B, C and D) whilst the other regime is provides a comparable result (A).

### Example 2

The following composition was prepared;

| | % by weight |
|---|---|
| Cationic fabric softener (4) | 15.58% |
| Cetyl trimethyl ammonium chloride | 1.88% |
| Sucrose polyerucate (1) | 4.40% |
| Coconut 20 EQ nonionic surfactant | 0.68% |
| Rewoquat CPEM | 0.18% |
| Hardened tallow fatty acid | 0.68% |
| Water, preservative, dye, | to 100% |
| perfume, antifoam | |

(1) see above.
(4) 1, 2 bis [hardened tallowoyloxy]-3-trimethylammonium propane chloride, (78.5% active composition) available from Clariant.

Fifteen 40 cm×40 cm cotton sheeting test cloths (plus 1 Kg cotton sheeting ballast load) were washed in a Miele FLA washing machine with 60 g of commercially available washing powder. The cloths were then conditioned with either Example 2 or the comparative example was added at an amount to give 0.25% wt of the active fabric softener compound on fabric. For example 2 only the cationic softener was counted as the active and not the oily sugar derivative.

In this test comparative examples A and B were again used.

Firstly, the test cloths were assessed for creasing prior to ironing on a 0 to 100 scale (100=very creased whilst 0= not creased at all). Each cloth was panelled by 10 assessors.

Secondly 15 panellists were asked to iron 3 cloths each (one cloth of each treatment) to their satisfaction. The time take to achieve this was recorded and each panellist was also asked to assess the following performance factors on a 1 to 5 scale;

1) ease of crease removal (1=difficult, 5=easy)

2) iron glide across the fabric (1=drags heavily, 5= glides easily)

3) perceived speed of ironing the fabric (1=slow, 5=very quick).

The results are shown in Table 3.

TABLE 3
results of the ease of ironing tests.

| | Time to iron | Base of | | |
|---|---|---|---|---|
| | to | crease | Iron | Perceived |
| Example | satisfaction | removal | Glide | speed |
| A | 15.0 | 2.93 | 2.90 | 3.03 |
| B | 12.9 | 3.77 | 3.70 | 3.67 |
| 2 | 9.6 | 3.90 | 3.93 | 3.83 |

The time (in minutes) taken to iron to iron the fabrics clearly shows the benefits of Example 2 over and commercially available rinse conditioner.

The time to iron measurement shows that example 2 has good ease of ironing benefits. The iron glide and the perceived speed results also demonstrate the advantages of example 2 when compared to the Comparative results with respect to the way that the iron moves over the fabric. This demonstrates that the ironing does not take as long and that it is considered by the person ironing that the iron is easier to move over the fabric.

### Example 3

The following wash-cycle compositions were prepared by simple mixing of the ingredients.

| | Example | Example | Example | Example |
|---|---|---|---|---|
| Component | C | 3 | 4 | 5 |
| Sodium | 20% | 20% | 20% | 20% |
| triphosphate | | | | |
| Cationic | 3% | 3% | 3% | 3% |
| surfactant (1) | | | | |
| Nonionic | 18% | 18% | 18% | 18% |
| surfactant (2) | | | | |
| Oily sugar | — | 15% | 15% | 15% |
| derivative (3) | | | | |
| Cationic | — | — | 1% | |
| polymer (4) | | | | |
| Cationic | — | — | — | 0.1% |
| polymer (5) | | | | |
| Water | To 100% | To 100% | To 100% | To 100% |

(1) Cetyl trimethyl ammonium chloride, ex Aldrich
(2) 1:1 wt ratio mixture of (11-13 alcohol ethoxylate with 7EO (available as Symperonic A7 from Unichema) with 3EO (available as Symperonic A3 from Unichema).
(3) Sucroze polyerucate (see above)
(4) Cationic potato starch (available as softgel BDA, ex Avebe).
(5) Cationic guar gum (available as Jaguar C13s, ex Rhodia).

### Example 4

### Assessment of Fibre Lubrification

Each of the compositions was placed into a Tergotometer and water was added to make a 1 liter wash solution. Six white desized cotton sheets (20 cm×20 cm) were loaded into the Tergotometer, and washed at 40°C. with a standard agitation rate of 75 r.p.m. for 30 minutes. Each cloth was then rinsed 3 times in demineralised water, hand wrung and then line dried overnight.

The lubrication properties were assessed using a Kawabata shear tester (KES-FB-1) by shearing the fabric in the warp direction and obtaining the average of the six 2HG5 readings, given for each composition (2HG5 relates to shear hysteresis at a 5°shear angle). For details of the Kawabata Shear Tester see S. Kawabata, The Standardisation and Analysis of Hand Evaluation, 2nd Edition, The Textile Machinery of Japan, Osaka 1986 and for details of the method of measuring shear, see Finnimore & Koenig-Melliand Testilbericht 67 (1986)pp 509-516.

The results are given in the following table:

Larger 2HG5 values are indicative of greater inelasticity in shearing, increased wrinkling and reduced fabric lubrication.

| Example | Average 2HG5 readings (N/M) |
|---|---|
| C | 6.24 |
| 3 | 6.07 |
| 4 | 5.72 |
| 5 | 5.73 |

The results demonstrate that, in the presence of the oily sugar derivative, fabrics exhibited decreased wrinkling, and higher levels of lubrication. The benefits were particularly significant when a combination of different deposition aids was present (examples 4 and 5).

1. The use of a fabric treatment composition to provide anti-creasing properties and/or ease or ironing benefits to a fabric wherein said composition comprises;
(i) an oily sugar derivative which is a liquid or soft solid derivative of a cyclic polyol or of a reduced saccharide, said derivative resulting from 35 to 100% of the hydroxyl groups in said polyol or in said saccharide being esterified or etherified, and wherein said derivative has two or more ester or ether groups independently attached to a C₈-C₂₂ alkyl or alkenyl chain, and
(ii) one or more deposition aid(s).

2. The use according to claim 1 wherein the oily sugar derivative is a liquid or soft solid derivative of a cyclic polyol or of a reduced saccharide resulting from 40-80%, of the hydroxyl groups in said polyol or in said saccharide being esterified or etherified.

3. The use according to claim 1, wherein the oily sugar derivative is derived from a monosaccharide or disaccharide.

4. The use according to claim 1, wherein the deposition aid is selected from cationic surfactants, cationic fabric softening compounds, cationic polymers and mixtures thereof.

5. The use according to claim 4, wherein the deposition aid is a cationic fabric softening compound having two or three C₈-C₂₈ alkyl or alkenyl chains connected to a nitrogen atom, preferably via at least one ester link.

6. The use according to claim 5, wherein the composition comprises between 1.5-20% by weight of the cationic fabric softening compound, based on the total weight of the composition.

7. The use according to claim 4, wherein the cationic surfactant is present in an amount of 0.01 to 5% by weight, preferably 0.1% to 2% based on the total weight of the composition.

8. The use according to claim 4, wherein the cationic polymer is present in an amount of 0.01 to 5% by weight based upon the total weight of the composition.

9. The use according to claim 1 wherein the composition is a fabric softening composition for use in the rinse cycle of a domestic washing process.

10. The use according to claim 1 wherein the composition is a detergent composition for use in the wash cycle of a domestic washing process.

11. A method of reducing the creasing of fabric by applying thereto during a laundering operation the composition defined in claim 1.

12. A method of providing ease of ironing benefits by applying thereto during a laundering operation the composition defined in claim 1.

13. A fabric treated with a composition as defined in claim 1.
